(19) United States
(12) Patent Application Publication
(10) Pub. No.: US 2008/0221792 A1
(43) Pub. Date: Sep. 11, 2008

(54) Navigation apparatus

(75) Inventor: Takaaki Nakayama, Okazaki-shi (JP)

Correspondence Address: BACON & THOMAS, PLLC, 625 SLATERS LANE, FOURTH FLOOR, ALEXANDRIA, VA, 22314-1176, US

(73) Assignee: AISIN AW CO., LTD., Anjo-shi (JP)

(21) Appl. No.: 12/071,313

(22) Filed: Feb. 20, 2008

(30) Foreign Application Priority Data
Mar. 5, 2007 (JP) 2007-054336

(51) Int. Cl. G01C 21/34

(52) U.S. Cl. 701/211

(57) ABSTRACT

When a first guidance reissue request is placed following voice guidance, it is likely that a driver has failed to hear the voice guidance and, therefore, guidance having a content identical to the initial guidance is issued (only the distance is modified). Beginning with a second guidance reissue request, on the other hand, it is likely that the driver desires different information, and therefore the guidance is reissued after modifying its content, e.g. an additional guidance item is modified while the content of the basic guidance item remains the same. The additional guidance may be modified by modifying the content of the item or by adding items.

### INCORPORATION BY REFERENCE

The disclosure of Japanese Patent Application No. 2007-054336 filed on Mar. 5, 2007 including the specification, drawings and abstract is incorporated herein by reference in its entirety.

### BACKGROUND OF THE INVENTION

1. Field of the Invention

The present invention relates to a navigation device which is capable of receiving and processing a guidance reissue request from a driver after issuing voice guidance.

2. Description of the Related Art

Navigation devices that generate a screen display of the current position of a vehicle and a map of the vicinity of the vehicle and perform a travel route search and guidance to a destination have become widely used. The guidance performed by such a navigation device includes, not only screen display, but also voice guidance.

Navigation devices having a function enabling repeat of the most recent voice guidance, responsive to button operation when the driver fails to hear or wishes to confirm the voice guidance, are also known.

Japanese Patent Application Publication No. 2001-324990, for example, discloses a technique for storing the content of voice guidance in memory and reissuing the voice guidance in accordance with the stored content of the memory, responsive to a request by a user.

### SUMMARY OF THE INVENTION

In certain cases, for example when the driver wishes to listen carefully to the guidance, when the driver wishes to obtain more detailed information, and when the driver has sufficient time to perform an operation and listen to the voice guidance, the driver may request repeat of the voice guidance many times.

However, in the known navigation devices capable of repeating voice guidance, only the distance from the object (subject) of the guidance changes, regardless of the number of times the driver requests repeat of the guidance, and the remainder of the content of the guidance remains the same.

It is therefore an object of the present invention to provide reissue of guidance that better conforms to a driver's needs.

According to the present invention, a counter counts the number of requests for repeat (reissue) of guidance for the same guidance subject, and when a request is made through a guidance repeat (reissue) requesting unit, the guidance content is modified according to the counted number of requests, after which the guidance is reissued and, therefore, reissued guidance better conforming to the driver's needs can be provided.

### BRIEF DESCRIPTION OF THE DRAWINGS

FIG. 1 is a block diagram of a navigation device according to an embodiment of the present invention;

FIG. 2 is a flowchart of a first example of voice guidance processing by the navigation device of FIG. 1; and

FIG. 3 is a flowchart of a second example of voice guidance processing by the navigation device of FIG. 1.

### DETAILED DESCRIPTION OF THE PREFERRED EMBODIMENTS

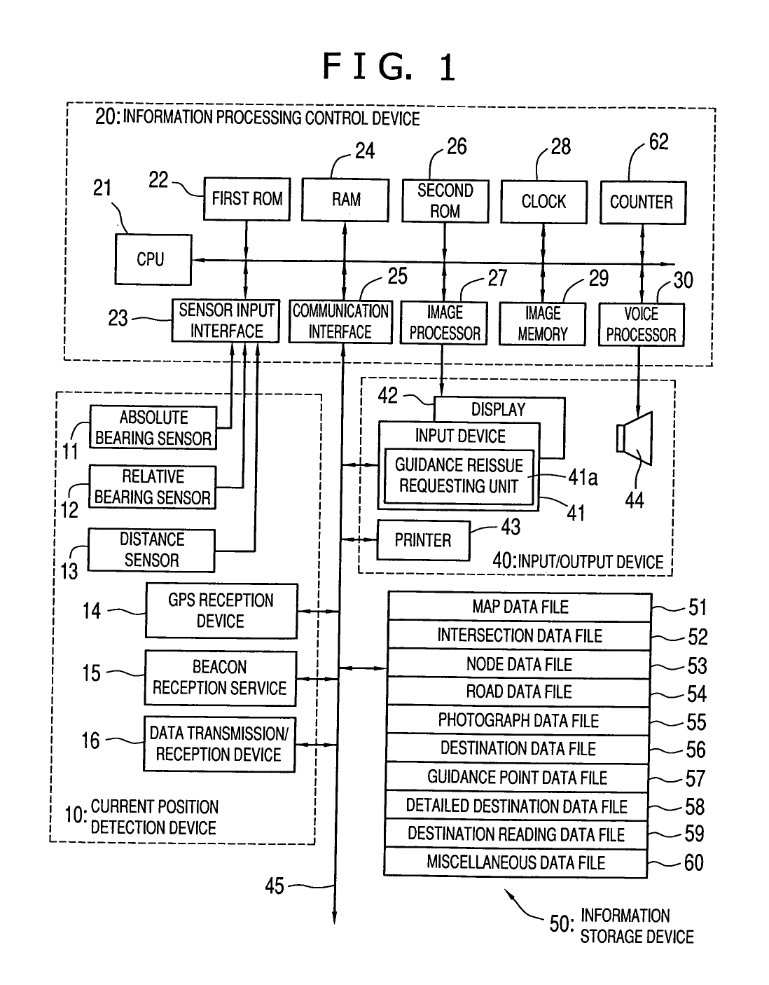

A preferred embodiment of a navigation device (apparatus) according to the present invention will be described in detail below with reference to FIGS. 1 to 3.

### (1) Outline of the Embodiment

In use of the navigation device according to this embodiment, a travel route to a destination is set, and voice guidance relating to the travel direction and so on is provided in accordance with the set travel route. The navigation device determines whether or not the current position of the vehicle corresponds to a guidance point on the set travel route, and when an affirmative determination is made, voice guidance (initial guidance) is issued. For example, when the guidance subject is a junction, initial guidance such as “Turn left in approximately 300 m. The supermarket XX marks the spot” is issued at a predetermined distance ahead of (in advance of) the junction.

The content of the voice guidance includes a basic guidance content, that constantly serves as the guidance subject, and an additional guidance content (and optionally non-guidance subjects) are determined according to the number of requests for guidance reissue. The basic guidance content includes “distance information” such as “in approximately 300 m”, “in approximately 700 m” and “imminently”, and “junction (or interjection) direction guidance” such as “straight ahead”, “turn right” or “turn left”. The additional guidance may include “landmark guidance” such as “the supermarket XX marks the spot”, “head toward guidance” such as “head toward XX”, “intersection guidance” such as “at City Hall South” (the name of an intersection) and so on.

The basic guidance content (items) is issued regardless of the number of requests for guidance reissue, but distances such as 300 m, 700 m and “imminently” are modified according to the distance to the guidance subject at the time of the request for guidance reissue. The content (items) of additional guidance is modified according to the number of requests, from the second reissue request on.

In this embodiment, when a first request for guidance reissue is made, it is likely that the driver has failed to hear the guidance, and therefore guidance having an identical content to the initial guidance (only the distance is modified as below) is provided. Beginning with the second guidance reissue request, on the other hand, it is likely that the driver wishes to receive different information, and therefore guidance is provided after modifying the structure (content) of the additional guidance item, although the content of the basic guidance remains the same and is repeated.

Modification of the additional guidance item may be modification by alteration of the structure (content) of the additional guidance (first example) and/or modification by addition of new content (items) (second example). In structural modification, when “landmark guidance” is provided in the initial guidance, the landmark is changed to “head toward guidance” in the second guidance reissue (third output including the “basic” or “initial” guidance) and “intersection guidance” in the third guidance reissue, for example. In modification through addition, when “landmark guidance” is provided in the initial guidance, “head toward guidance” is added to the “landmark guidance” in the second guidance reissue (third output), and “intersection guidance” is added to the “landmark guidance” and the “head toward guidance” in the third guidance reissue, for example. Note, however, that the order of the basic guidance and additional guidance may differ in actual voice guidance according to the content of each item of guidance.

The content of the additional items of guidance is stored for each guidance subject (point), and a determination is made in advance as to whether or not to issue additional guidance items in the initial guidance, and if so, which additional guidance item(s) is to be issued. The order of modification of the additional guidance items is also determined in advance, but an order of precedence may be regularized in advance according to the type of guidance subject (intersection, junction, turn, head toward guidance, and so on).

### (2) Details of the Embodiment

As shown in FIG. 1 the navigation device according to this embodiment is installed in a vehicle and includes a current position detection device 10, an information processing control device 20, an input/output device 40 and an information storage device 50.

The current position detection device 10 includes an absolute bearing sensor 11 which is a geomagnetic sensor that detects the direction in which the vehicle is headed by detecting the N direction on the basis of a magnet, for example.

A relative bearing sensor 12 detects whether or not the vehicle has turned at an intersection, for example, and may be an optical rotation sensor or a potentiometer attached to a rotary element of the steering system, or an angle sensor attached to a vehicle wheel. A gyrosensor that detects angular change using angular velocity may also be used. In other words, any unit that is capable of detecting angular change relative to a reference angle (the absolute bearing) may be used. A distance sensor 13 may be a unit that detects and counts the number of vehicle wheel rotations or a unit that detects acceleration and integrates it twice, for example. In other words, any unit that is capable of measuring the distance of movement of the vehicle may be used.

A GPS (Global Positioning System) reception device 14 receives signals from an artificial satellite, and is capable of obtaining various information such as the signal transmission time, positional information relating to the location of the reception device, the speed of movement (travel) of the reception device and the advancement direction of the reception device. A beacon receiver 15 receives signals transmitted by a transmission device disposed in a specific geographical location (stationary). The beacon reception device 15 is capable of obtaining VICS (Vehicle Information and Communication System) information, in particular, as well as information relating to vehicle travel such as congestion information, current position information and parking lot information.

A data transmission/reception device 16 communicates with other such devices remote from the vehicle, using a telephone line or radio waves for information exchange. For example, the data transmission/reception device 16 may be capable of inputting and outputting travel-related information using a variety of methods such as automobile telephone, ATIS (Automatic Terminal Information Service), VICS, GPS correction and inter-vehicle communication.

The information processing control device (means) 20 is a device for performing calculations and control on the basis of information input from the current position detection device 10 and the input/output device 40 and information stored in the information storage device 50, and for control to ensure that the calculation results are output to the appropriate unit such as a display 42, a printer 43 or a speaker 44. The information processing control device 20 includes a central processing unit (CPU) 21 which provides overall calculation and control of the entire navigation device, and also executes voice guidance processing. The information processing control device 20 further includes a first ROM 22, a RAM 24, a second ROM 26, a clock 28 and a guidance request counter (“counting unit”) 62. The first ROM 22 stores navigation-related programs, in particular, navigation programs relating to current position detection, route searches, display guidance, voice guidance, etc. The RAM 24 stores information input by a user such as destination information and transit point information, which are input through an input device to be described below, the results of calculations performed by the CPU 21 on the basis of the information input by the user, the results of a route search, and map information read from the information storage device 50. The communication interface 25 is a unit for inputting and outputting information from the current position detection device 10, in particular, information obtained from the remote locations. The second ROM 26 stores navigation-related programs, in particular, navigation programs relating to travel route guidance and geographical location guidance. The image processor 27 converts vector information processed by the CPU into image information which is then stored in image memory 29.

Also included in the information processing control device are a sensor input interface 23, which receives information from the current position detection device 10, a communication interface 25, an image processor 27, an image memory 29 and a voice processor 30. The clock 28 detects the current time. The guidance reissue request counter 62 counts the number of requests input through the guidance reissue requesting unit 41a relating to the same guidance subject. The voice processor 30 processes voice information read from the information storage device 50 and voice information for voice guidance reissuance, which is read from the RAM 24.

The input/output device 40 includes an input device 41 into which data such as a destination, transit points and search conditions are input by the user, the display 42 for displaying images, the printer 43 for printing information, and the speaker 44 for outputting a voice. The input device 41 includes a touch panel, a touch switch, a joystick, and/or a key switch, for example. The input device of this embodiment is provided with a guidance reissue request key (“guidance reissue requesting unit” or “guidance reissue requesting means”) 41a for requesting the reissuance of voice guidance. The guidance reissue request key may be incorporated into the display 42 in the form of a touch panel or a touch switch, or may be in the form of an independent button or switch.

The display 42 displays a map of the vicinity of the current location and a travel route to the destination. The information storage device 50 is connected to the information processing control device 20 via a transmission line 45. The information storage device 50 stores a map data file 51, an intersection data file 52, a node data file 53, a road data file 54, a photograph data file 55, a destination data file 56, a guidance point data file 57, a detailed destination data file 58, a destination reading data file 59, and a miscellaneous data file 60. The information storage device 50 may be in the form of an optical storage medium such as a DVD-ROM or a CD-ROM, or a magnetic storage medium such as a hard disk, or in the form of various other information storage media such as a magneto-optical disk or semiconductor memory.

To provide travel route guidance the navigation unit detects the current position (location) using the current position detection device 10, reads map information relating to the vicinity of the current position from the map data file 51 in the information storage device 50, and displays the read map information on the display unit 42. When a destination is input through the input device 41, the information processing control device (means) 20 searches for (calculates) a plurality of travel route candidates from the current position to the destination and displays the travel route candidates on the map displayed on the display unit 42. Then, when the driver selects one of the travel routes, the selected travel route is stored in the RAM 24. Thus, the navigation unit serves as a travel route acquisition unit (means) to obtain, set and store a travel route.

Optionally, the information processing control device 20 may obtain the travel route by transmitting the current vehicle position (or an input point of departure) and the destination to an information processing center and receiving a travel route to the destination that has been determined by search in the information processing center. In this case, communication of the destination and travel route is performed by wireless communication via the communication interface 25. Alternatively, a travel route from the departure point to the destination may be searched for using an information processing device such as a home personal computer or the like, whereupon the travel route is stored in a storage medium such as USB memory and obtained via a corresponding storage medium reading device. In this case, the storage medium reading device is connected to the information processing control device 20 via the transmission line 45.

A travel route may also be obtained by estimating a destination from the current time and current position and searching for a travel route to the estimated destination. For example, the destination may be estimated by storing travel history data, extracting travel data obtained at the same time (including the day of the week) and relating that extracted travel data to a route between identical points, such as in the case in which the driver drives the vehicle to his/her office (the geographical location of which has been registered) at around 7 o'clock on weekdays, and creating a database of departure points, destinations and departure times. Then, when the current time is 7 o'clock on a weekday and the current location is the home of the driver, for example, it is estimated that the destination is the driver's office, and a travel route from home to the driver's office is retrieved from memory.

While the vehicle is moving, route guidance is performed by tracking the current position detected by the current position detection device 10. In route guidance, the vehicle position on the map is determined by map matching between road data corresponding to the set travel route and the current position detected by the current position detection device 10. A map of the vicinity of the current vehicle position is then displayed on the display unit 42, and the set travel route and current position are displayed on the map. Further, a determination is made as to whether or not guidance is required from the relationship between the position of a guidance subject (object or location, e.g. an intersection) on the searched travel route and the current position. In other words, determinations such as whether or not travel route guidance at a predetermined turning point or the like and directional guidance are required are made when the vehicle has been traveling in a straight line for a predetermined distance or more. When it is determined that guidance is required, guidance is provided visually on the display 42 and audibly as voice guidance.

Voice guidance (voice guidance processing) includes initial guidance, which is performed automatically by the navigation device in accordance with the current position (location) of the vehicle relative to a guidance subject or guidance point, and guidance reissuance, which is output responsive to a guidance reissue request from the driver.

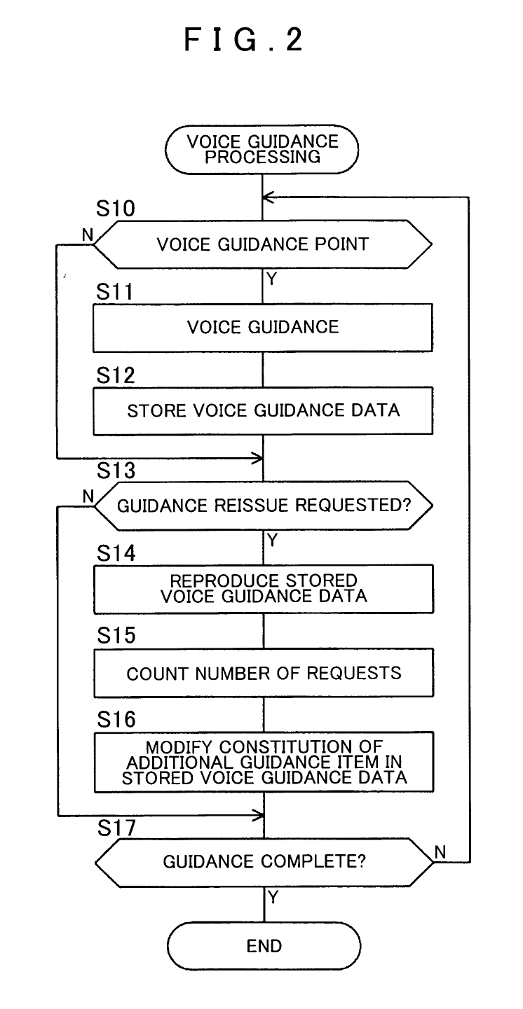

FIG. 2 is a flowchart illustrating a first example of a voice guidance routine in accordance with the present invention. As shown in FIG. 2, the information processing control device 20 monitors whether or not the vehicle has reached a voice guidance point relating to a guidance subject that is ahead of the vehicle on the set travel route (step 10). When the vehicle has not reached the voice guidance point, the process advances to step 13 in order to monitor guidance reissue requests relating to guidance subjects for which initial guidance has already been issued.

On the other hand, when the vehicle reaches a voice guidance point (step 10; Y), the information processing control device 20 issues voice guidance relating to the guidance subject (step 11), and stores the voice guidance data used in the initial guidance in a predetermined area of the RAM 24 in preparation for a voice guidance reissue request from the driver (step 12).

Next, the information processing control device 20 monitors whether or not a voice guidance reissue request has been placed by the driver using the guidance reissue requesting unit 41a (step 13). If not (step 13; N), the routine advances to step 17. In this case, when guidance is not complete in step 17, the routine returns to step 10. However, the voice guidance processing of steps 11 and 12 is not performed until the vehicle reaches the next voice guidance point and, instead, the routine advances to step 13 from step 10. Thus, guidance reissue requests are monitored constantly until the vehicle reaches the next voice guidance point.

When a guidance reissue request has been placed by the driver (step 13; Y), the information processing control device 20 calculates the distance from the guidance subject to the current vehicle position and, after modifying the distance component of the guidance in accordance with the calculated distance, reproduces the voice guidance data stored in the RAM 24 (step 14). The initial guidance data is stored in the RAM 24, and therefore, when the guidance reissue request is placed for the first time, the content of the first reissue guidance is identical to the content of the initial voice guidance.

The counting unit 62 of the information processing control device 20 counts the number of guidance reissue requests (step 15), and in preparation for the next (second and subsequent) guidance reissue request, modifies the content of the additional guidance item of the voice guidance data stored in the RAM 24 in accordance with the counted number of requests (step 16). Note that counting of the number of guidance reissue requests in step 15 may be performed before step 14 or after step 16, as long as the count corresponds to the modification content of step 16. In step 16, the information processing control device 20 modifies the content of the additional guidance item in accordance with the number of guidance reissue requests in an order such as that shown in the following example. It is assumed that the initial guidance includes the basic guidance items “distance guidance” and “junction direction guidance” and the additional guidance item is “intersection guidance” such that, for example, the guidance “Turn left at City Hall South in approximately 700 m” is issued.

(a) First guidance reissue request: “junction direction guidance”+“intersection guidance”+“distance guidance”, i.e. “Turn left at City Hall South in approximately 500 m”.
(b) Second guidance reissue request: “junction direction guidance”+“distance guidance”+“landmark guidance”, i.e. “Turn left in approximately 300 m. The supermarket XX marks the spot”.
(c) Third guidance reissue request: “junction direction guidance”+“distance guidance”+“head toward guidance”, i.e. “Turn left in approximately 300 m. Head toward Nagoya”. In the foregoing example of guidance reissuance, each additional guidance item is underlined.

In the example described above, in the content of the first guidance reissue, only the distance of the basic guidance items is modified from 700 m to 500 m assuming that the driver wishes to reconfirm the content of the initial guidance. The remainder of the content of the reissued guidance is identical to the content of the initial guidance stored in the RAM 24 in step 12. Beginning with the second reissue of guidance, the content of the additional guidance item is modified sequentially, in addition to the modification (updating) of the distance of the basic guidance items, assuming that the driver desires “guidance” rather than “reconfirmation”. In the above example, the additional guidance item is changed (modified) from “intersection guidance” (at City Hall South) in the initial guidance and in the first reissue to “landmark guidance” (the supermarket XX marks the spot) and then to “head toward guidance” (head toward Nagoya).

In this embodiment, the order of the additional guidance items is determined in advance for each guidance subject, and therefore modification is performed in this order. When the final additional guidance item has been issued, the next guidance reissue returns to the first additional guidance item.

However, a rule may be determined (set) for the orders of precedence of the additional guidance items with modification performed in accordance with this rule. For example, the sequence of “intersection guidance”, “landmark guidance” and “head toward guidance” may be regularized as the order of precedence of the additional guidance items such that guidance is issued in that order for the guidance subject that has the highest order of precedence. In so doing, the need to determine individual orders (sequence) for each guidance subject is eliminated. Further, in addition to this order of precedence, a special sequence for modifying the order of precedence may be determined for each guidance subject. More specifically, in the rule described above, the additional guidance item “landmark guidance” has a lower order of precedence than “intersection”, but when there is a building or the like that is easier for the driver to recognize as a guidance subject than a road sign at the intersection, the “landmark guidance” relating to the building or the like may be given a higher order of precedence. Guidance relating to individual guidance subjects that have been set in a special order is issued preferentially over the regularized order of precedence.

While in the above example, a single additional guidance item is provided in the initial guidance, two or more additional guidance items may be provided. For example, when a, b, c, d, e . . . are set as the additional guidance items, the structure of the additional guidance items is modified sequentially such that a and b are issued in the initial guidance, c and d are issued in the second guidance reissue, and e and f are issued in the third guidance reissue. Partial modification may also be performed such that a and b are issued in the initial guidance, b and c are issued in the second guidance reissue, and c and d are issued in the third guidance reissue.

Returning to FIG. 2, after modifying the structure of the voice guidance data stored in the RAM 24, the information processing control device 20 determines whether or not guidance is complete, either on the basis of whether or not a guidance stopping operation has been performed by the navigation device or on the basis that the ignition has been switched off. When guidance is complete (step 17; Y), the processing is terminated. When guidance is not complete (step 17; N), on the other hand, the information processing control device 20 returns to step 10 in preparation for the next guidance reissue request (step 10; N→step 13) and in preparation for initial guidance relating to the next guidance subject (step 10; Y), and continues voice guidance processing.

A second example of voice guidance processing will now be described. In the first example described with reference to the flowchart in FIG. 2, the content of the additional item of guidance is modified according to the number of guidance reissue requests, but in this second example, the number of additional guidance items output responsive to a given request is modified according to the number of guidance reissue requests.

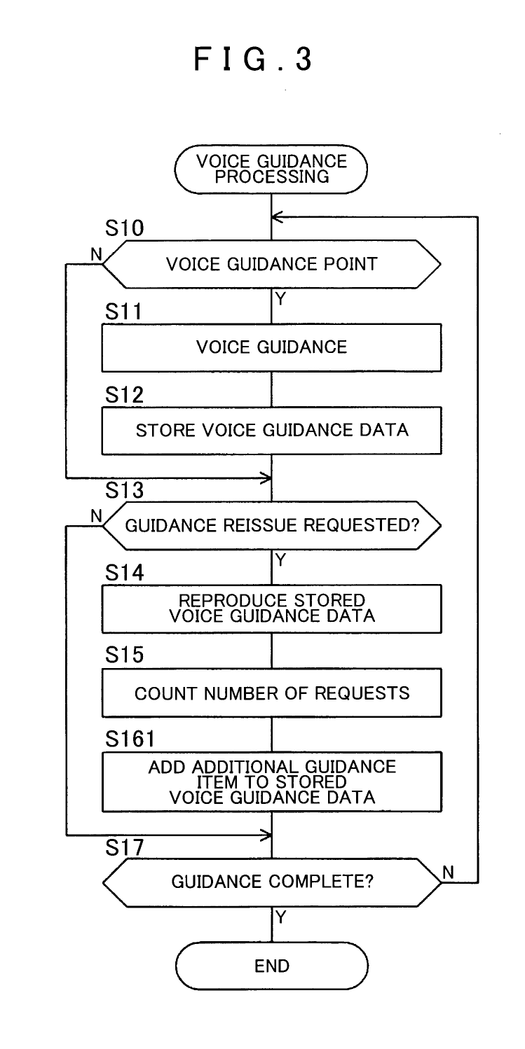

FIG. 3 is a flowchart illustrating the content of voice guidance processing according to the second example. In the flowchart shown in FIG. 3, step 161 differs from step 16 of the first example shown in FIG. 2. Since all other steps are identical, the same step numbers have been assigned thereto and description thereof has been omitted.

In step 161 of the second example, the information processing control device 20 adds additional guidance items sequentially in accordance with the number of guidance reissue requests (the strength of the request). Similarly to the first example, it is assumed that the initial guidance includes the basic guidance items “distance guidance” and “junction direction guidance” and that the additional guidance item is “intersection guidance” such that, for example, the guidance becomes “Turn left at City Hall South in approximately 700 m”.

In the following example, the added additional guidance items are underlined.
(a) First guidance reissue request: “junction direction guidance”+“intersection guidance”+“distance guidance”, e.g. “Turn left at City Hall South in approximately 500 m”.
(b) Second guidance reissue request: “junction direction guidance”+“intersection guidance”+“distance guidance”+“landmark guidance”, e.g. “Turn left at City Hall South in approximately 300 m. The supermarket XX marks the spot”.
(c) Third guidance reissue request: “junction direction guidance”+“intersection guidance”+“distance guidance”+“head toward guidance”+“landmark guidance”, e.g. “Turn left at City Hall South in approximately 300 m. Head toward Nagoya. The supermarket XX marks the spot”.

Similar to the first example, in the second example, only the distance item among the basic guidance items is modified, i.e. from 700 m to 500 m, in the first guidance reissue, assuming that the driver wishes to reconfirm the content of the initial guidance. The remainder of the reissued guidance is identical in content to the initial guidance stored in the RAM 24 in step 12. Beginning with the second guidance reissue, the distance item among the basic guidance items is modified and additional guidance items are added sequentially in accordance with the number of guidance reissue requests, assuming that the driver desires “guidance” rather than “reconfirmation”. In the above example, additional guidance items are added to “intersection guidance” of the initial guidance in the first reissue, in order of “landmark guidance”, “head toward guidance”, etc.

In the above-described embodiment, when a guidance reissue request is input for reissue of voice guidance regarding the same guidance subject, the guidance content is modified (the content of the additional item is modified or additional items are added) in accordance with the number of guidance reissue requests, and therefore, rather than listening to the same guidance repeatedly, the driver can listen to different guidance information (additional guidance items) in accordance with the number of guidance reissue requests. In other words, the guidance reissuance conforms to the driver's desire for information. Further, the initial guidance is repeated (included) in the first guidance reissue, and therefore a driver who failed to hear the basic guidance can reconfirm its content. Optionally, the user may modify the number of times the initial guidance is repeated.

An embodiment of the navigation system and method according to the present invention was described above, but the present invention is not limited to the foregoing embodiment or examples, and may have various modifications within the scope of the claims. For example, in the embodiment described above, where the content of the additional guidance item is modified according to the number of guidance reissue requests (first example) and where additional guidance items are added (second example) were described as the manner in which the additional guidance is modified, but the additional guidance may be modified in both ways, i.e. modifying the content of the additional guidance item and adding additional guidance items in accordance with the number of guidance reissue requests. For example, an additional guidance item may be added responsive to the second guidance reissue request, whereas the additional guidance items may be modified responsive to the third guidance reissue request. In this case, the modification responsive to the third request may be applied to all of the additional items, including the item added responsive to the second request, or to only a part of the additional items. The addition and content modification may be performed in any order.

Further, in the embodiment described above, the guidance content is modified according to the number of guidance reissue requests, but a determination as to whether to repeat the previous guidance content or to modify the content (by modifying the content of the additional item and/or by adding additional items) may be made in accordance with the time interval between the initial guidance and the first guidance reissue request or the time interval between a guidance reissue responsive to the previous guidance reissue request and the next guidance reissue request. More specifically, when the time interval is equal to or smaller than a predetermined threshold, the previous guidance is repeated assuming that the driver wishes to listen to the previous guidance content again, and when the time interval is greater than the threshold, the guidance content is modified and reissued.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

What is claimed is:

1. A navigation device comprising:
a travel route acquisition unit for obtaining a travel route;
a voice guidance unit for providing voice guidance relating to a guidance subject on the obtained travel route;
a guidance reissue requesting unit for inputting a request for reissue of the voice guidance; and
a counting unit for counting a number of requests input through the guidance reissue requesting unit relating to the same guidance subject,
wherein, when a request is input through the guidance reissue requesting unit, the voice guidance unit modifies the guidance content in accordance with the counted number of requests, and then reissues the guidance.

2. The navigation device according to claim 1, wherein the voice guidance unit reissues guidance having the same guidance content as an initial guidance in response to a first request for guidance reissue, and, starting with a second guidance reissue request, reissues the guidance after modifying the guidance content.

3. The navigation device according to claim 1, wherein the guidance relating to the guidance subject includes a basic guidance item and an additional guidance item, and
the voice guidance unit modifies the additional guidance item in accordance with the counted number of requests and then reissues guidance as the basic guidance item in combination with the modified additional guidance item.

4. The navigation device according to claim 1, wherein the guidance relating to the guidance subject includes a basic guidance item and an additional guidance item, and
the voice guidance unit adds an additional guidance item in accordance with the counted number of requests and then reissues guidance as the basic guidance item in combination with the added additional guidance item.

5. The navigation device according to claim 4, wherein the basic guidance item includes distance to a road junction and direction to be taken at the road junction, and
the voice guidance unit modifies the distance of the basic guidance item according to a distance from a current position to the road junction in both the initial guidance and in the reissued guidance.

6. The navigation device according to claim 3, wherein the basic guidance item includes distance to a road junction and direction to be taken at the road junction, and
the voice guidance unit modifies the distance of the basic guidance item according to a distance from a current position to the road junction in both the initial guidance and in the reissued guidance.

7. A navigation method comprising:
searching map data to determine a travel route;
outputting initial voice guidance relating to a guidance subject on the determined travel route;
inputting a request for reissue of voice guidance;
counting the number of inputs of request for voice guidance relating to the same guidance subject;
modifying the content of the most recent previously output voice guidance in accordance with the counted number of requests; and
outputting the modified voice guidance.

8. The navigation method according to claim 7, wherein the modified voice guidance has the same content as the initial guidance in response to a first request for guidance reissue, and, starting with a second guidance reissue request, reissues the guidance after modifying the guidance content.

9. The navigation method according to claim 7, wherein the voice guidance relating to the guidance subject includes a basic guidance item and an additional guidance item, and wherein the modifying of the content of the voice guidance is by modifying the additional guidance item in accordance with the counted number of requests and then reissuing the voice guidance as the basic guidance item in combination with the modified additional guidance item.

10. The navigation method according to claim 7, wherein the guidance relating to the guidance subject includes a basic guidance item and an additional guidance item, and the modifying includes adding an additional guidance item in accordance with the counted number of requests and wherein voice guidance is then reissued as the basic guidance item in combination with the added additional guidance item.

11. The navigation method according to claim 10, wherein the basic guidance item includes distance to a road junction and direction to be taken at the road junction, and wherein the distance item in the basic guidance is modified according to a distance from a current position to the road junction in both the initial guidance and in the reissued guidance.

12. The navigation method according to claim 9, wherein the basic guidance item includes distance to a road junction and direction to be taken at the road junction, and wherein the distance item in the basic guidance is modified according to a distance from a current position to the road junction in both the initial guidance and in the reissued guidance.
